(19) United States
(12) Patent Application Publication
(10) Pub. No.: US 2009/0040212 A1
(43) Pub. Date: Feb. 12, 2009

(54) DRIVER AND DRIVER CIRCUIT FOR PIXEL CIRCUIT

(75) Inventor: Chen Yu Wang, Tainan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: HIMAX TECHNOLOGIES LIMITED, Tainan County (TW)

(21) Appl. No.: 11/835,348

(22) Filed: Aug. 7, 2007

(51) Int. Cl. G06F 3/038

(52) U.S. Cl. 345/214

(57) ABSTRACT

The driver includes a digital-to-analog converter receiving a pixel value and outputting one of gamma voltages corresponding to the pixel value, and an output stage providing a driving voltage and a driving current corresponding to the gamma voltage outputted from the digital-to-analog converter, in which the driving voltage is provided during a first part of the programming period and the driving current is provided during a second part of the programming period.

### BACKGROUND OF THE INVENTION

1. Field of the Invention

The present invention relates to a driver and driver circuit for a pixel circuit, and more particularly, to a driver and driver circuit which employ a hybrid driving technique.

2. Description of the Related Art

In the field of AMOLED (Active Matrix Organic Light-Emitting Diode), the display using AMOLED is still limited to a small size due to the disadvantages of programming methods in the market. The common programming methods for an AMOLDE panel are classified into voltage programming and current programming methods. The advantages of the voltage programming method include a shorter settling time and easy Gamma correction. However, the voltage programming method exhibits imperfect compensation for threshold voltage and mobility shifts caused by variations of manufacturing processes. The current programming method can overcome the shortcomings of the voltage programming method, that is, the former can provide perfect compensation for threshold voltage and mobility. However, when dealing with low gray-scale, the current programming method suffers from a long settling time. This situation gets worse when the panel size increases.

Therefore, it is necessary to develop a novel programming method for the AMOLDE panel with a short settling time, and perfect compensation for threshold voltage and mobility shifts.

### SUMMARY OF THE INVENTION

The first aspect of the present invention is to provide a hybrid programming method for a pixel circuit, which combines the advantages of the voltage and current programming methods applied during different periods, so as to obtain a short settling time and perfect compensation for threshold voltage and mobility shifts.

The second aspect of the present invention is to provide a driver for a pixel circuit having a capacitor charged during a programming period, which provides a driving voltage and a driving current to the pixel circuit during different periods, so as to obtain a short settling time and perfect compensation for threshold voltage and mobility shifts.

The third aspect of the present invention is to provide a driver circuit providing a driving voltage and current for a pixel circuit according to a pixel, which acts as a unit gain buffer, so as to enhance the driving capacity.

The present invention also provides a driver for a pixel circuit having a capacitor charged during a programming period. The driver includes a digital-to-analog converter receiving a pixel value and outputting one of gamma voltages corresponding to the pixel value, and an output stage providing a driving voltage and a driving current corresponding to the gamma voltage outputted from the digital-to-analog converter, in which the driving voltage is provided during a first part of the programming period and the driving current is provided during a second part of the programming period.

The present invention further provides a driver circuit providing a driving voltage and current for a pixel circuit according to a pixel value. The driver circuit includes an impedance, an operational amplifier, and a switch. The impedance has a first end coupled to receive a supply voltage. The operational amplifier has a positive input coupled to receive a gamma voltage corresponding to the pixel value. The switch is controlled by an output of the operational amplifier and is coupled between the pixel circuit and a negative input of the operational amplifier. The negative input and the output of the operational amplifier are commonly coupled to the pixel circuit during a first part of a programming period, and a second end of the impedance is coupled to the negative input of the operational amplifier during a second part of the programming period.

### BRIEF DESCRIPTION OF THE DRAWINGS

The invention will be described according to the appended drawings in which:

FIGS. 1(a) and 1(b) show embodiments of a driver.

FIG. 2 shows an alternative circuit of the resistive element;

FIG. 3 shows a timing diagram of control signals of the switches in FIGS. 1(a) and 1(b);

FIGS. 4(a) and 4(b) show other embodiments of a driver;

FIG. 5 shows an alternative circuit of the resistive element;

FIG. 6 shows a timing diagram of control signals of the switches in FIGS. 4(a) and 4(b); and

FIG. 7 shows the voltage waveform of the present invention.

### DETAILED DESCRIPTION OF THE INVENTION

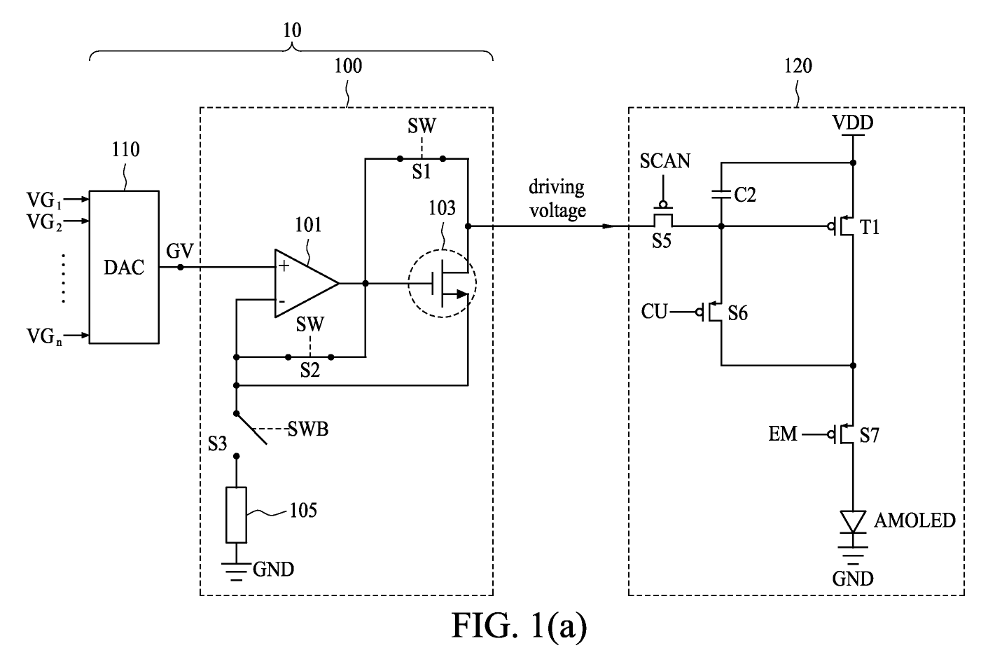

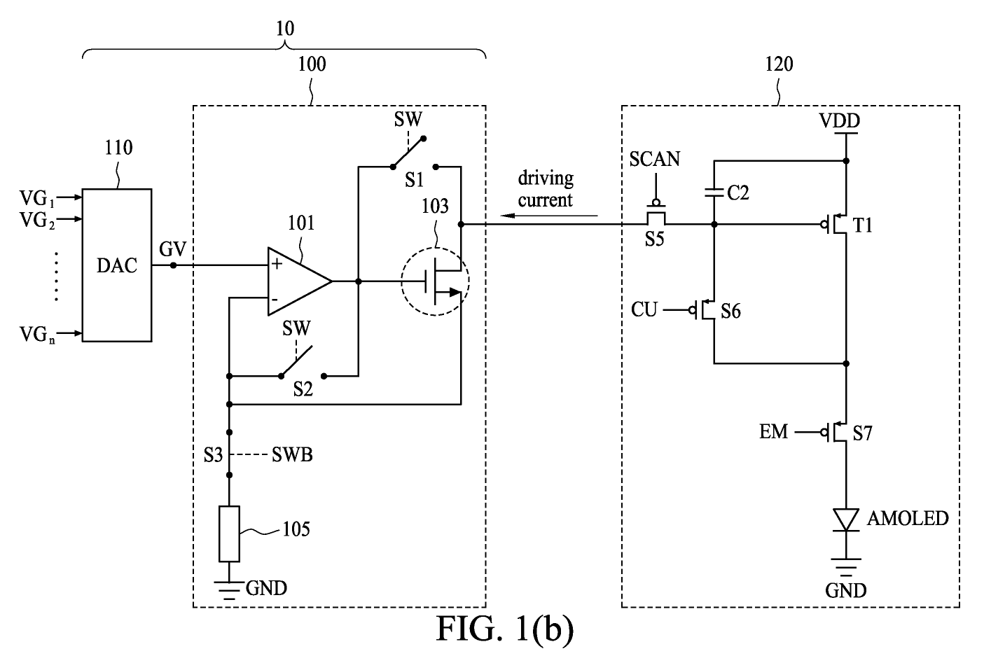

FIGS. 1(a) and 1(b) show embodiments of a driver 10 for a pixel circuit 120, which operate during two different periods. The driver 1 includes a digital-to-analog converter (DAC) 110 and an output stage 100. The DAC 110 receives a pixel value and outputs a gamma voltage VG selected from plural gamma voltages VG₁-VGₙ, in which the gamma voltage GV corresponds to the pixel value. The output stage 100 could be equivalent to a unit gain buffer, which comprises an operational amplifier 101, a first switch S1, a second switch S2, a third switch S3, a fourth switch 103 and a resistive element or impedance 105. The operational amplifier 101 receives the gamma voltage from the DAC 110. The first switch S1 and second switch S2 are configured to determine a feedback path electrically coupled between an output end and a negative input of the operational amplifier 101. The third switch S3, fourth switch 103 and resistive element 105 are configured to receive a supply voltage. The output stage 100 provides a driving voltage DV and a driving current DI corresponding to the gamma voltage VG outputted from the DAC 110. The driving voltage DV is provided during a first part of the programming period and the driving current DI is provided during a second part of the programming period. The pixel circuit 120 includes a fifth switch S5, a sixth switch S6 and a seventh switch S7. The fifth switch S5 conducts the driving voltage and the driving current to charge a storage capacitor C2. The sixth switch S6 passes the driving current from a supply source (VDD), and through a driving transistor T1 to the fifth switch S5. The seventh switch S7 passes a driving current to the AMOLED pixel, where the driving current corresponds to the potential difference between the gate and the source of the driving transistor T1.

FIG. 1(a) shows the step of providing the driving voltage. In the first step, the gamma voltage to a positive input of an operational amplifier 101 is provided. In the second step, the first switch S1 and second switch S2 are closed, and the third switch S3 is open. Therefore, a feedback path is established. Further, because of a virtual short, the driving voltage through the feedback path is applied to a negative input of the operational amplifier 101. In terms of the pixel circuit 120, a storage capacitor C2 of the pixel circuit 120, which the driving voltage is used to charge, is charged by turning on a fifth switch S5 and turning off a sixth switch S6 and a seventh switch S7 during the first part of the programming period.

FIG. 1(b) shows the step of providing the driving current. In the first step, the gamma voltage to a positive input of an operational amplifier 101 is provided. In the second step, the first switch S1 and second switch S2 are open, and the third switch S3 and a fourth switch 103 are closed. Therefore, a grounding path and a feedback path are established. Further, the driving current flowing through the grounding path is conducted to a ground. In terms of the pixel circuit 120, the storage capacitor C2 of the pixel circuit 120, which the driving current is used to charge, is charged by turning on a fifth switch S5 and sixth switch S6, and turning off the seventh switch S7 during the second part of the programming period.

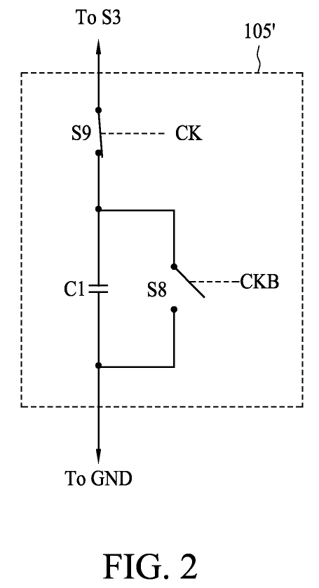

FIG. 2 shows an alternative circuit of the resistive element 105. In FIG. 1(b), the driving current is determined by the gamma voltage and a resistive element 105. For example, the driving current is equal to the gamma voltage divided by the resistance of the resistive element 105. However, the resistive element 105 can be replaced by a capacitor switching circuit 105′. The capacitor switching circuit 105′ includes an eighth switch S8, a capacitor C1 and a ninth switch S9. The eighth switch S8 is controlled by a clock signal CK. The capacitor C1 is connected to the eighth switch S8 in parallel, and one end of the capacitor C1 is connected to the supply voltage. The ninth switch S9 is connected between the other end of the capacitor C1 and the third switch S3, and is controlled by an inverted signal of the clock signal CKB. Through two non-overlapping clocks, CK and CKB, which control the switches S8 and S9, respectively, the driving current could be generated in a more flexible manner.

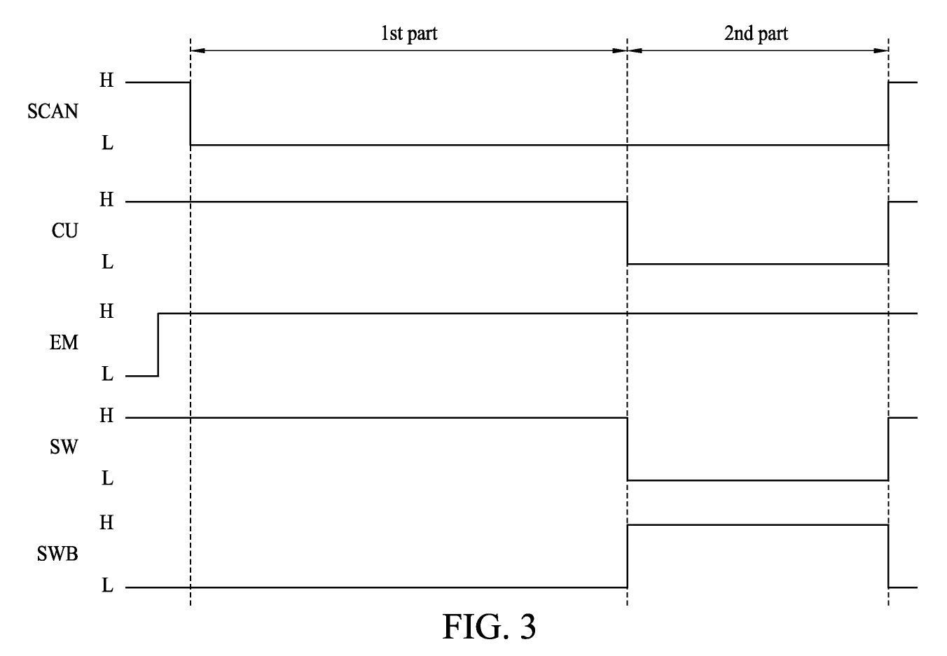

Following the above descriptions about the time the switches turn on and turn off, FIG. 3 shows a timing diagram of control signals of the switches in FIGS. 1(a) and 1(b).

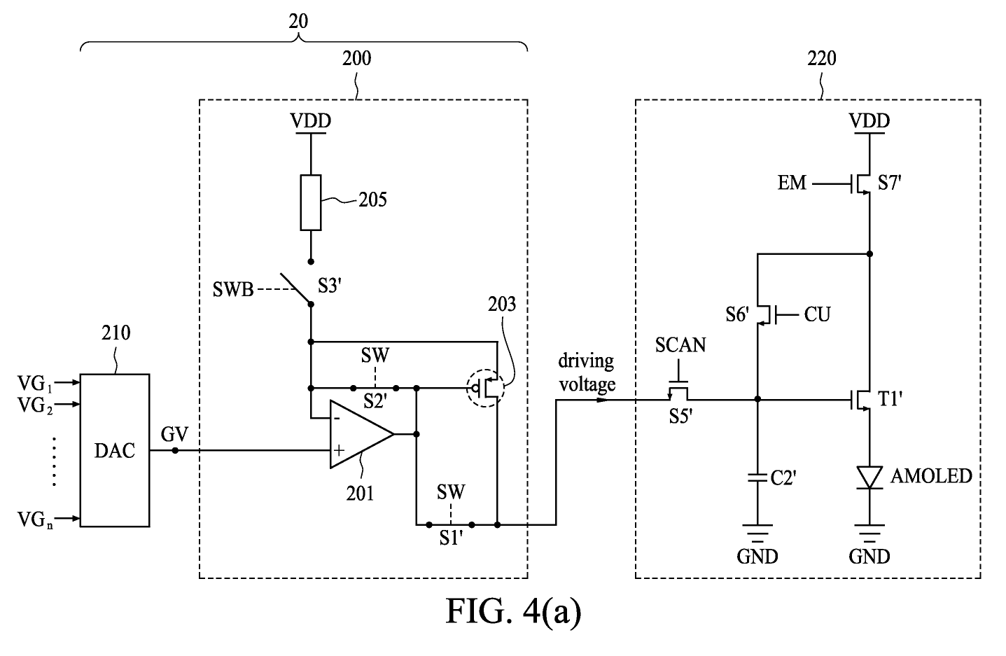

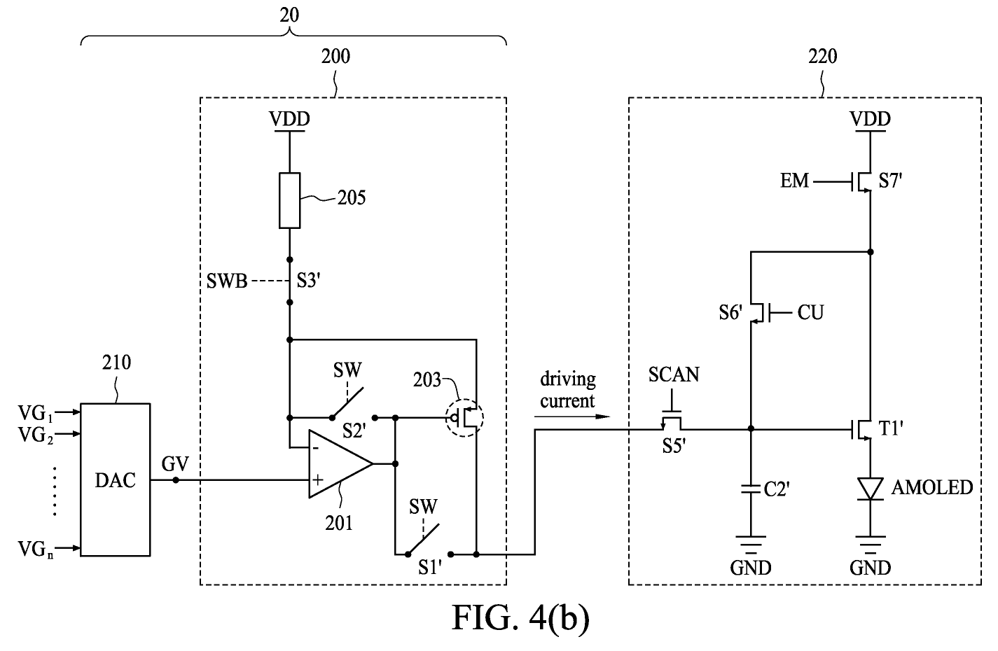

FIGS. 4(a) and 4(b) show other embodiments of a driver 20 for a pixel circuit 220, having a capacitor charged during a programming period according to the present invention, which operate during two different periods. The driver 20 includes a digital-to-analog converter (DAC) 210 and an output stage 200. Similar to FIGS. 1(a) and 1(b), the output stage 200 comprises an operational amplifier 201, a first switch S1′, a second switch S2′, a third switch S3′, a fourth switch 203 and a resistive element 205. The operational amplifier 201 receives the gamma voltage from the DAC 210. The first switch S1′ and second switch S2′ are configured to determine a feedback path electrically coupled between an output end and a negative input of the operational amplifier 201. The third switch S3′, fourth switch 203 and resistive element 205 are configured to receive a supply voltage. The output stage 200 provides a driving voltage DV and a driving current DI corresponding to the gamma voltage VG outputted from the DAC 210. The driving voltage DV is provided during a first part of the programming period and the driving current DI is provided during a second part of the programming period. The pixel circuit 220 includes a fifth switch S5′, a sixth switch S6′ and a seventh switch S7′. The fifth switch S5′ conducts the driving voltage and the driving current to charge a storage capacitor C2′. The sixth switch S6′ passes the driving current from a supply source VDD, and through the fifth switch S5′ to a driving transistor T1′. The seventh switch S7′ passes a driving current to the AMOLED pixel, where the driving current corresponds to the potential difference between the gate and the source of the driving transistor T1′.

FIG. 4(a) shows the step of providing the driving voltage. In the first step, the gamma voltage to a positive input of an operational amplifier 201 is provided. In the second step, the first switch S1′ and second switch S2′ are closed, and the third switch S3′ is open. Therefore, a feedback path is established. Further, because of virtual short, the driving voltage through the feedback path is applied to a negative input of the operational amplifier 201. In terms of the pixel circuit 220, a storage capacitor C2′ of the pixel circuit 220, which the driving voltage is used to charge, is charged by turning on a fifth switch S5′ and turning off a sixth switch S6′ and a seventh switch S7′ during the first part of the programming period.

FIG. 4(b) shows the step of providing the driving current according to another embodiment of the present invention. In the first step, the gamma voltage to a positive input of an operational amplifier 201 is provided. In the second step, the first switch S1′ and second switch S2′ are open, and the third switch S3′ and fourth switch 203 are closed. Therefore, a power supply path and a feedback path are established. Further, the driving current flowing through the power supply path is conducted from a supply source VDD.

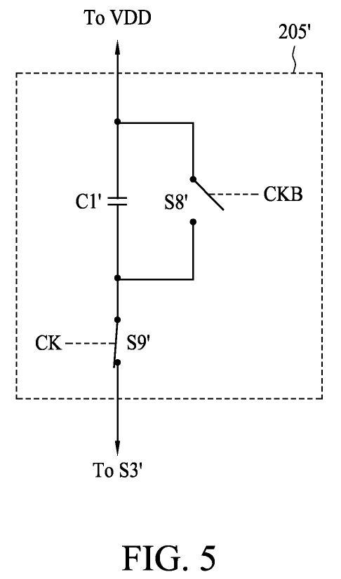

FIG. 5 shows an alternative circuit of the resistive element 205. In FIG. 4(b), the driving current is determined by the gamma voltage and a resistive element 205. However, the resistive element 205 can be replaced by a capacitor switching circuit 205′. Through two non-overlapping clocks, CK and CKB, which control the switches S8 and S9, respectively, the driving current could be generated in a more flexible manner.

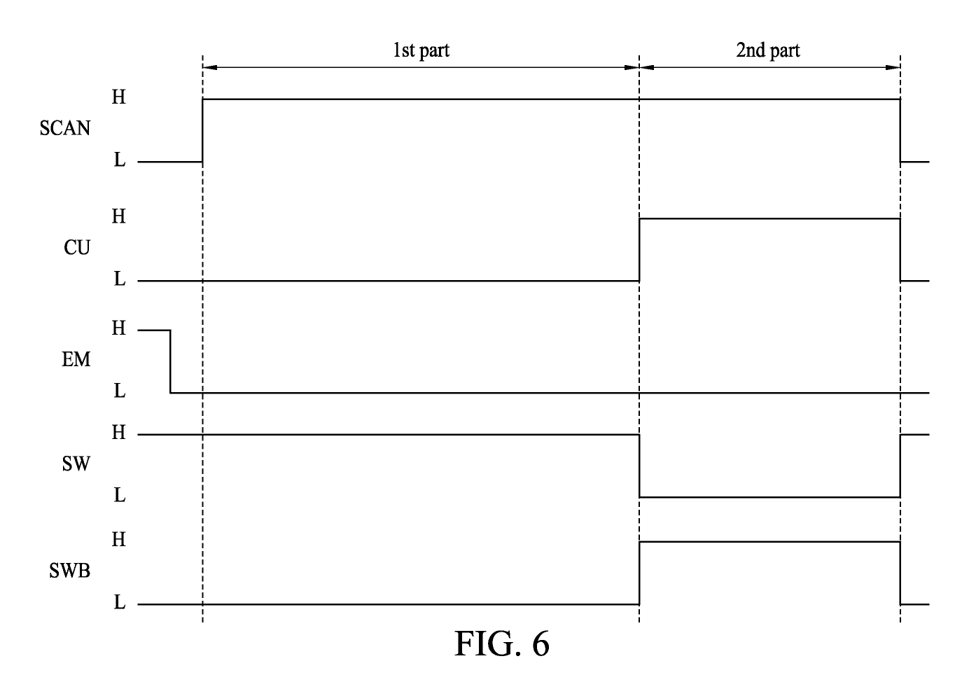

Following the above descriptions about the time the switches turn on and turn off, FIG. 6 shows a timing diagram of control signals of the switches in FIGS. 4(a) and 4(b).

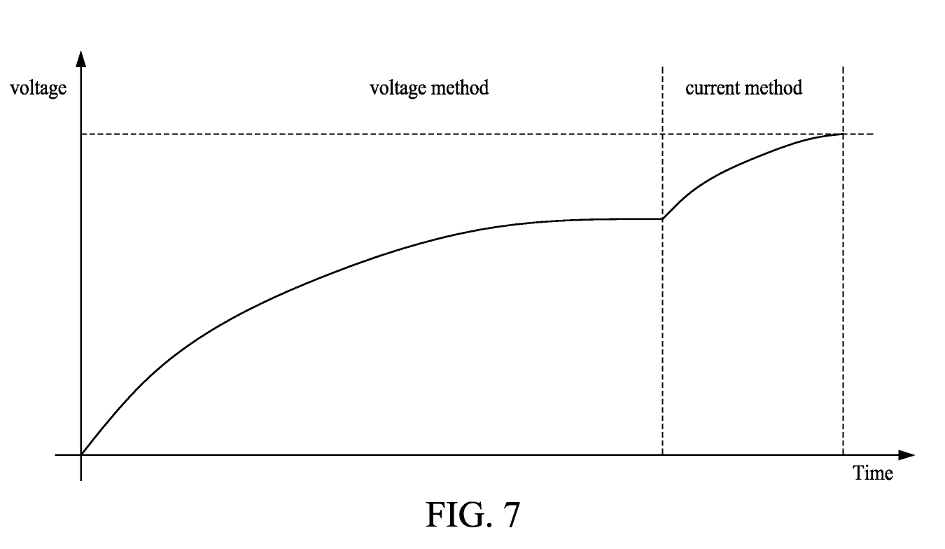

FIG. 7 shows the voltage waveform of the present invention. Through a time division, the scanning time of the present invention is divided into two programming modes. The first one is a voltage method, which acts as a coarse tune with the advantage of providing a fast convergence. The second one is a current method, which acts as a fine tune with the advantage of providing an accurate approach.

The above-described embodiments of the present invention are intended to be illustrative only. Numerous alternative embodiments may be devised by those skilled in the art without departing from the scope of the following claims.

What is claimed is:

1. A driver for a pixel circuit having a capacitor charged during a programming period, the driver comprising:
a digital-to-analog converter receiving a pixel value and outputting one of gamma voltages corresponding to the pixel value; and
an output stage providing a driving voltage and a driving current corresponding to the gamma voltage outputted from the digital-to-analog converter;
wherein the driving voltage is provided during a first part of the programming period and the driving current is provided during a second part of the programming period.

2. The driver of claim 1, wherein the output stage comprises:
an operational amplifier receiving the gamma voltage;
a first switch and a second switch configured to determine a feedback path electrically coupled between an output end and a negative input of the operational amplifier; and
a third switch, a fourth switch and a resistive element configured to receive a supply voltage.

3. The driver of claim 2, wherein the first switch and the second switch are closed to provide the driving voltage to charge a storage capacitor of the pixel circuit.

4. The driver of claim 3, wherein the feedback path is electrically connected between the output end and the negative input of the operational amplifier.

5. The driver of claim 2, wherein the fourth switch is a transistor turned on to conduct the driving current to charge a storage capacitor of the pixel circuit.

6. The driver of claim 2, wherein the driving current is equal to the gamma voltage divided by the resistance of the resistive element.

7. The driver of claim 5, wherein the feedback path comprising the transistor is electrically connected between the output end and the negative input of the operational amplifier.

8. The driver of claim 1, wherein the output stage is equivalent to a unit gain buffer.

9. The driver of claim 2, wherein the resistive element comprises:
an eighth switch controlled by a clock signal;
a capacitor connected to the eighth switch in parallel, and one end of the capacitor connected to the supply voltage; and
a ninth switch connected between the other end of the capacitor and the third switch, and controlled by an inverted signal of the clock signal.

10. The driver of claim 2, wherein the pixel circuit comprises:
a fifth switch conducting the driving voltage and the driving current to charge a storage capacitor;
a sixth switch passing the driving current from a supply source, and through a driving transistor to the fifth switch; and
a seventh switch passing a driving current to the AMOLED pixel, wherein the driving current corresponds to the potential difference between the gate and the source of the driving transistor.

11. The driver of claim 2, wherein the pixel circuit comprises:
a fifth switch conducting the driving voltage and the driving current to charge a storage capacitor;
a sixth switch passing the driving current from a supply source, and through the fifth switch to a driving transistor; and
a seventh switch passing a driving current to the AMOLED pixel, wherein the driving current corresponds to the potential difference between the gate and the source of the driving transistor.

12. The driver of claim 2, wherein the supply voltage is a supply source.

13. The driver of claim 2, wherein the supply voltage is a ground voltage.

14. A driver circuit providing a driving voltage and current for a pixel circuit according to a pixel value, comprising:
an impedance having a first end coupled to receive a supply voltage;
an operational amplifier having a positive input coupled to receive a gamma voltage corresponding to the pixel value; and
a switch controlled by an output of the operational amplifier and coupled between the pixel circuit and a negative input of the operational amplifier;
wherein the negative input and the output of the operational amplifier are commonly coupled to the pixel circuit during a first part of a programming period, and a second end of the impedance is coupled to the negative input of the operational amplifier during a second part of the programming period.

15. The driver circuit of claim 14, further comprising:
a first switch coupled between the pixel circuit and the output of the operational amplifier;
a second switch coupled between the negative input and the output of the operational amplifier; and
a third switch coupled between the second end of the impedance and the negative input of the operational amplifier;
wherein the first and second switches are turned on and the third switch is turned off during the first period, and the first and second switches are turned off and the third switch is turned on during the second period.

16. The driver circuit of claim 15, wherein the impedance comprises:
a fourth switch controlled by a clock signal and having a first end coupled to the negative input of the operational amplifier;
a capacitor having one end coupled to a second end of the fourth switch and the other end coupled to receive the supply voltage; and
a fifth switch controlled by an inverted signal of the clock signal and having one end coupled to the second end of the fourth switch and the other end coupled to receive the supply voltage.

17. The driver circuit of claim 16, wherein the supply voltage is a ground voltage.

18. The driver circuit of claim 16, wherein the supply voltage is a supply source.
